(19) United States
(12) Patent Application Publication
(10) Pub. No.: US 2007/0128406 A1
(43) Pub. Date: Jun. 7, 2007

(54) Packing member and method for manufacturing packing member

(76) Inventor: Taeko Yoshida, Kanagawa (JP)

Correspondence Address: MORRISON & FOERSTER LLP, 1650 TYSONS BOULEVARD, SUITE 400, MCLEAN, VA, 22102, US

(21) Appl. No.: 11/335,690

(22) Filed: Jan. 20, 2006

(30) Foreign Application Priority Data
Dec. 7, 2005 (JP) 2005-352896

(51) Int. Cl. B32B 3/10

(52) U.S. Cl. 428/136; 206/814

(57) ABSTRACT

A packing member for packing a packed material where plastic films are superimposed on one another and a space for air chambers is formed inside by performing thermal adhesion on the plastic films to seal the plastic films, the packing member using three or more plastic films and including a plurality of air chambers that accommodate gas, wherein gas is filled in the air chambers through a blowing-in port to make the air chambers accommodate gas so that gas is prevented from leaking to the outside. Accordingly, a packing member that can be manufactured easily and can stably pack a packed material, and a method for manufacturing the packing member can be provided.

### BACKGROUND OF THE INVENTION

1) Field of the Invention

The present invention relates to a packing member that confines gas such as air therein and packs a material to be packed to prevent an impact on the packed material, and a method for manufacturing a packing member that packs a packed material.

2) Description of the Related Art

In general, various industrial products including consumer goods and electronics are packed using a box-like member such as a cardboard box to be transported or stored. An entire article including its corners and edges is protected by wrapping the article with a plastic sheet, in several layers, including, for example, air caps in order to prevent an impact on the packed article within the box.

However, such a plastic sheet including air caps is often discarded after one-time use thereof, which is not desirable in view of environmental protection including waste disposal problems. Since an entire plastic sheet is bulky due to a large volume of air caps therein, carrying expense for transportation and warehouse expense for stacking prior to use thereof for packing become high, being considerably uneconomical. Accordingly, a packing member not requiring a large space and prevents an impact on an article is required.

For example, Japanese Patent Application Laid-open No. 2000-128246 (Patent Literature 1) discloses a packing material including a sheet and a plurality of kinds of hollow projections with different shapes each containing gas therein. The patent application also describes that a packing material serving as both a protective member and a cushioning member can be provided by such a constitution. However, even if the packing material can be utilized as the cushioning member, the patent application does not describe the above problems.

Japanese Patent Application Laid-open No. 2002-104520 discloses a cushioning and packing material including a supply passage formed of a first film layer and a second film layer, a plurality of injecting chambers formed of the first film layer and the second film layer and connected to an end of the supply passage via a check valve, and a plurality of air chambers formed of the second film layer and a third film layer having fine pores. Japanese Patent Application Laid-open No. 2004-182332 discloses an airbag-type cushioning material for packing obtained by superimposing two rectangular resin films on one another, and attached with an air blowing-in member having a check valve structure. In the cushioning material for packing, a seal portion for sectioning for forming an air chamber that provides air flow and a cushioning function by contacting with a packed material is formed of an adhesive seal portion obtained by forming a thermal seal portion on an outer peripheral edge of the cushioning material for packing utilizing heat sealing process and printing adhesive at a predetermined portion on at least one of the two resin films. Japanese Patent Application Laid-open No. 2000-288782 discloses a packing structure including a plurality of airbag bodies having an air passage connecting to an air blowing-in port and a plurality of air chambers formed adjacently via respective check valves facing the air passage.

However, in each of the conventional techniques, many check valves are required for arrangement to respective air chambers, and continuous production becomes difficult due to necessity for an arranging work of the check valves to the respective air chambers, which hinders an improvement in manufacturing productivity. Remarkably small check valves must be arranged relative to the film sheet or the like, which complicates the constitution of the cushioning and packing material.

The present invention has been achieved in view of the above problems, and an object thereof is to provide a packing member that can be manufactured easily and continuously and that can stably pack a packed material therein, and a method for manufacturing the packing member.

### SUMMARY OF THE INVENTION

The invention provides a packing member for packing a material and configured to be inflated with a gas. The packing member includes a plurality of plastic films, an injection port through which the gas is injected for an inflation of the packing member, a plurality of air chambers formed by partial adhesions of corresponding plastic films and configured to accommodate the gas, an air accommodating portion that is provided for each of the air chambers and configured to be inflated with the gas, and a blowing-in port that is provided for each of the air accommodating portion and configured to provide a path of the gas into the air accommodating portion. The blowing-in port has a slit formed in one of the plastic films that is flexible enough to expand so that the slit is closed when the slit is pushed against another of the plastic films upon the inflation.

The invention also provides a method for manufacturing a packing member for packing a material and configured to be inflated with a gas. The method includes disposing a patterned layer of a release agent on a first plastic film, cutting slits in the first plastic film, adhering thermally a second plastic film to the first plastic film having the slits and the patterned layer so that an inlet portion and a passage of the gas are formed where the patterned layer is disposed, and adhering thermally a third plastic film to the first plastic film adhered to the second plastic film so that a discrete air chamber is formed for each of the slits between the first and third plastic films.

### BRIEF DESCRIPTION OF THE DRAWINGS

FIG. 1 is a schematic view showing a constitution of a packing member according to the present invention;

FIGS. 2A and 2B are schematic views showing a constitution of an air chamber, where FIG. 2A includes a plan view and a sectional view showing a schematic constitution of one air chamber, and FIG. 2B is a sectional view of the air chamber filled with air;

FIGS. 3A and 3B are schematic views showing a constitution of an air chamber according to another embodiment, where FIG. 3A is a sectional view showing a schematic constitution of one air chamber, and FIG. 3B is a sectional view of the air chamber filled with air;

FIG. 4 is a schematic view showing a method for manufacturing the packing member according to the present invention; and

FIGS. 5A and 5B are schematic views showing a portion to be subjected to a thermal adhesion process.

### DETAILED DESCRIPTIONS OF THE INVENTION

Exemplary embodiments of the present invention will be explained below with reference to the accompanying drawings. Since other embodiments will readily occur to those skilled in the art through changes and modifications of the invention within the spirit or scope of the present invention, such embodiments are embraced in the scope of the invention. Therefore, the following explanations of the embodiments are only exemplary and are not intended to limit the scope of the invention.

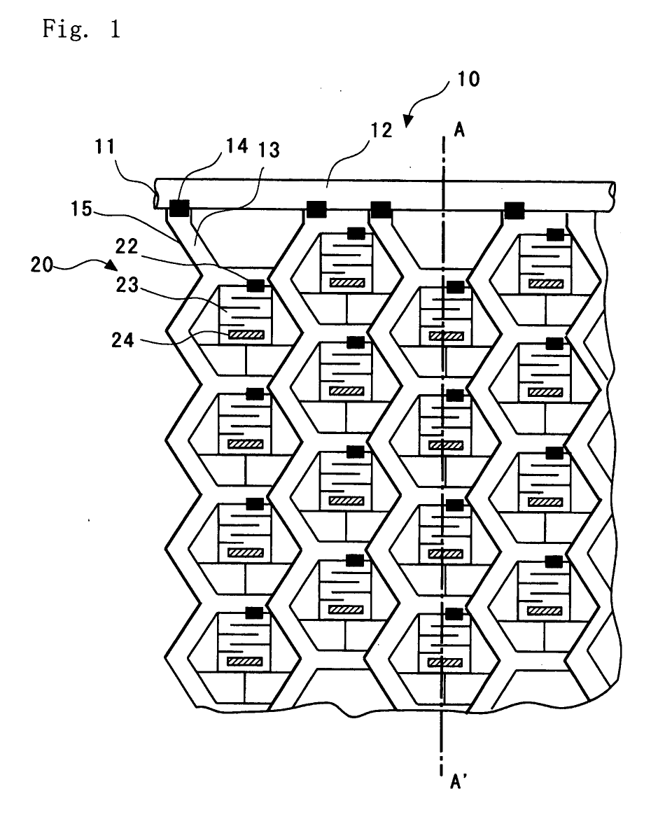

FIG. 1 is a schematic view showing a constitution of a packing member of an embodiment according to the present invention.

A packing member 10 of this embodiment includes many small air chambers 20. By wrapping the packing member 10 around a packed material, an impact is absorbed and the packed material is cushioned in a manner similar to the packing material of the air cap type obtained by providing air caps on a plastic film. In the packing material of the air cap type, since air is injected and confined in the packing material from the beginning, it is difficult to convey or store the packing material. However, since the packing member 10 of the embodiment is constituted such that air is injected to inflate the air chambers 20 at a time of use, it is easy to convey or store the packing member 10.

As shown in FIG. 1, the packing member 10 of the embodiment has an injection port 11 serving as an inlet for injecting air to feed air inside the air chambers, a first communication passage 12 allowing passage of the injected air, and second communication passages 13 serving as branches extending from the first communication passage 12, where the second communication passages 13 communicates with the air chambers 20. Each air chamber 20 is inflated by air injected from the injection port 11.

Air is injected from the first communication passage 12 to the second communication passages 13 via first communication ports 14. As shown in FIG. 1, each second communication passage 13 communicates with respective air chambers 20, and air is injected to the air chambers 20 via respective second communication ports 22.

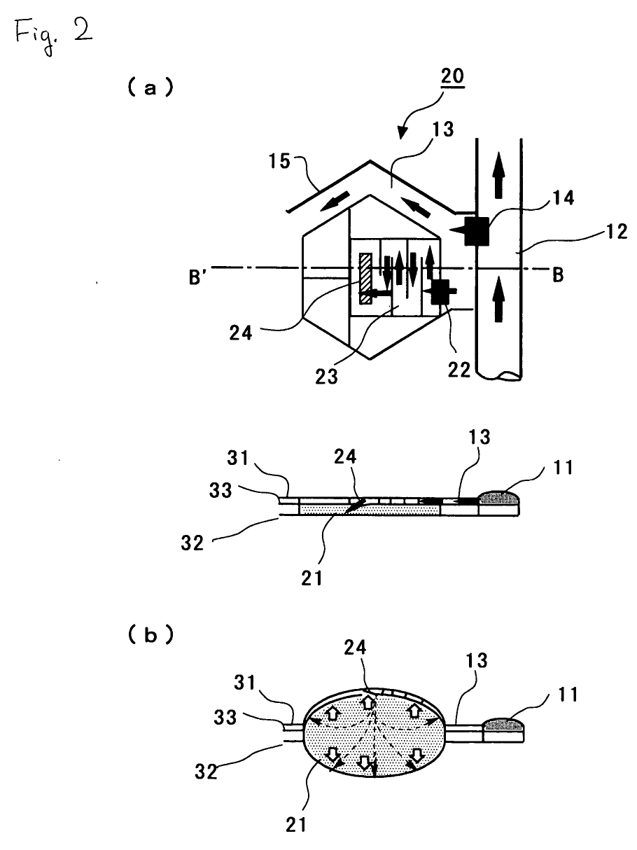

FIGS. 2A and 2B are schematic views showing a constitution of the air chamber 20, FIG. 2A including a plan view showing a schematic constitution of one air chamber and a sectional view of the air chamber taken along line B-B′, and FIG. 2B being a sectional view of the air chamber filled with air.

As shown in FIG. 1 and FIGS. 2A and 2B, the air chamber 20 includes an introducing passage 23 for guiding air and a blowing-in port 24 for blowing air into an air accommodating portion 21. It is preferable that the introducing passage 23 has a labyrinth structure or a narrow passage structure. The introducing passage 23 is preferably formed to be narrow in order to lengthen it to some extent. By making the introducing passage 23 narrow, a time period for filling the air accommodating portion 21 with the air can be adjusted.

Since the air chambers 20 are filled with air sequentially from the air chamber 20 positioned closest to the first communication passage 12 so that the second communication passage 13 is gradually narrowed according to respective inflations of the air chambers 20, if the introducing passage is short, injection of air to the air chamber 20 positioned far from the first communication passage 12 may be delayed.

The blowing-in port 24 is formed by cutting a slit in the film. Air is injected from the introducing passage 23 to the air accommodating portion 21 through the slit. The blowing-in port 24 may be formed in a U-shaped cutting. Since an area for air injection can be increased by forming the blowing-in port 24 in a U-shape, an injection speed of air can be increased. After air fills the air accommodating portion 21, the packing member 10 is easily deformed owing to property of plastic films constituting the packing member 10, so that a face of one film is easily pressed on a face of another film, thereby reducing leakage of air.

More specifically, as shown in FIGS. 2A and 2B, a first plastic film 31 and a second plastic film 32 constituting a base are arranged and a third plastic film 33 is arranged therebetween. As shown in FIG. 2A, air fills the air accommodating portion 21 from the injection port 11 via the blowing-in port 24. Injection of air is performed from the injection port 11 provided in one of the films through a straw inserted therein. Black arrows in FIGS. 2A and 2B show air flow and white arrows show a pressing force.

At this time, as shown in FIG. 2B, the third plastic film 33 is pushed up by pressure acting in a direction of arrows. The third plastic film 33 is pushed up to closely contact with the first plastic film 31, so that the blowing-in port 24 and the introducing passage 23 are made narrow. As a result, injection of air is suppressed in a self-controlling manner, so that the injection of air is stopped when a predetermined amount of air fills the air accommodating portion 21. Upon the filling, the blowing-in port 24 formed by the plastic film with high flexibility is pressed from its inside by the first plastic film 31 forming the introducing passage 23 to be closed, so that air is prevented from leaking from the air accommodating portion 21.

Conventionally, in an air cushioning material obtained by performing thermal adhesion on plastic films to form a bag and confining air in the bag, for example, check valves are used for confining air. That is, the check valves are frequently used in a state that one of two sheets of thermally adhesive plastic films printed or applied with release agent or the like for preventing adhesion through central portions thereof is superimposed on the other, the plastic films are thermally adhered at their both side edges on each other, and the check valve is sandwiched between the plastic films. However, since a manufacturing process for such a conventional air cushioning material using check valves includes different steps such as a printing step and a thermal melt-adhering step, these steps are troublesome. Especially, the check valve must be disposed on the plastic films before the thermal adhesion, which reduces productivity and increases manufacturing cost. Thus, the conventional method is unpractical.

Regarding performance of the check valve, since the check valve is constituted such that two films are pressed to approach to each other due to a difference between an internal pressure and an external pressure to close a flow passage for air, the check valve may be opened to cause air leakage due to application of a mechanical force thereto in some cases. Thus, the conventional air cushioning material is not highly reliable. However, since the packing member 10 of the embodiment uses a plastic film with high flexibility for the blowing-in port 24 without using a check valve, the blowing-in port 24 is pressed on the first plastic film 31 forming the introducing passage 23 by pressure of air filling the air accommodating portion so that air can be prevented from leaking.

The conventional air cushioning material requires many check valves for arrangement to respective air chambers, which not only reduces productivity but also increases manufacturing cost, being unpractical. On the other hand, the packing member 10 of the embodiment can prevent air leakage simply by using the flexible plastic film without using any check valve.

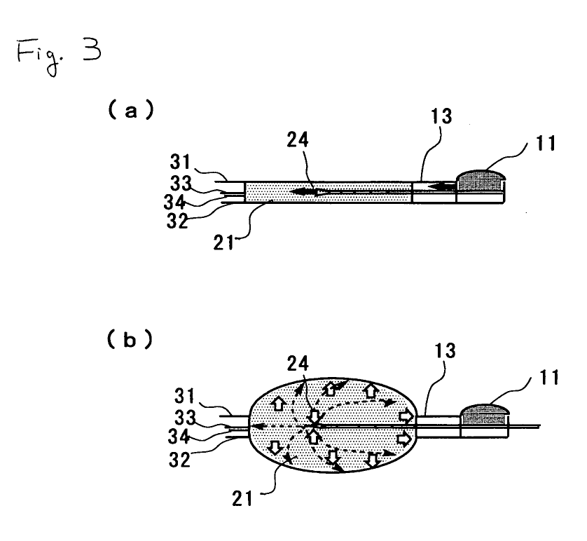

FIGS. 3A and 3B are schematic views showing a constitution of the air chamber 20 according to another embodiment, FIG. 3A being a sectional view showing a schematic constitution of one air chamber and FIG. 3B being a sectional view of the air chamber filled with air. While the packing member 10 has one film disposed between the first plastic film 31 and the uppermost second plastic film 32, two or more films may be disposed therebetween. As shown in FIGS. 3A and 3B, in the packing member 10 of the embodiment, the introducing passage 23 and the blowing-in port 24 are constituted by two sheets of films. When air fills the air accommodating portion 21, pressure inside the air accommodating portion 21 increases and the air chamber 20 inflates so that the introducing passage 23 and the blowing-in port 24 are closed by internal pressure inside the air accommodating portion 21. As shown in FIGS. 3A and 3B, the introducing passage 23 or the like may remain in the air accommodating portion 21 or it may be pressed by the first plastic film 31 or the like to be brought in close contact thereto. In either case, after air fills the air accommodating portion 21, the blowing-in port 24 is closed from its inside by internal pressure in the air accommodating portion 21, so that air in the air accommodating portion 21 is prevented from leaking.

A method for manufacturing the packing member 10 of the above embodiments will be explained.

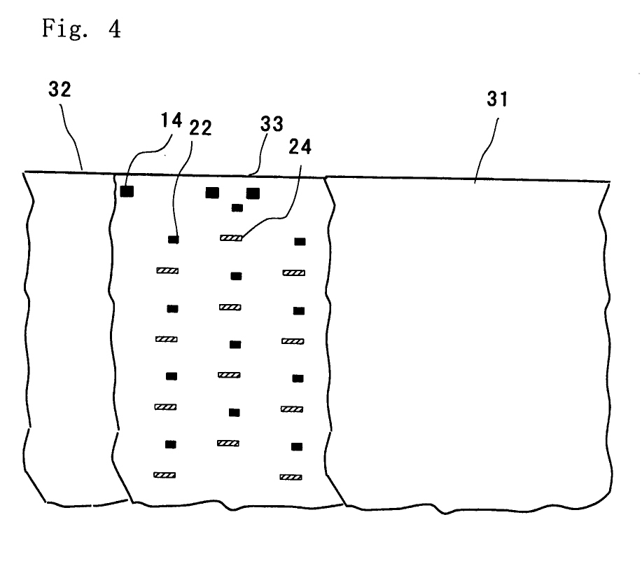

FIG. 4 is a schematic view showing the method for manufacturing the packing member 10 according to this method. The third plastic film 33 is disposed below the first plastic film 31 and the second plastic film 32 is disposed below the third plastic film 33. As shown in FIG. 4, the first and the second plastic films 31 and 32 do not require any processing. The third plastic film 33 disposed between the first and the second plastic films 31 and 32 is subjected to a processing such as application of release agent.

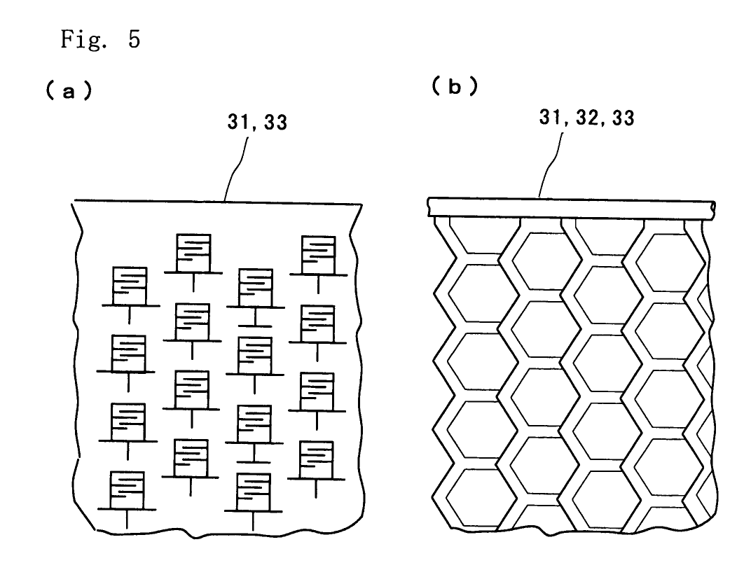

FIGS. 5A and 5B are schematic views showing a portion to be subjected to a thermal adhesion process. As shown in FIG. 5A, the blowing-in ports 24 are provided by cutting using many thin blades, the third plastic film 33 printed with or applied with release agent for preventing thermal adhesion to secure the communication ports 14 and 22 is superimposed on the first plastic film 31, and the introducing passages 23 and the communication ports 14 and 22 are formed by thermal adhesion. As shown in FIG. 5B, the second plastic film 32 is superimposed on the thermally adhered first and third plastic films 31 and 33 and the three plastic films are simultaneously thermally adhered. Thus, singular air chambers 20 independent from each other are provided. Even if one of the air chambers 20 is punctured, air does not leak from the other air chambers 20, because they are provided independently and singularly.

In FIG. 5B, the air chambers 20 can be made independent for each row of the air chambers 20 by performing thermal adhesion on partition portions 15 shown with thick solid lines extending vertically, as also shown in FIG. 1. Thus, even if the packing member 10 is cut vertically along line A-A′ shown in FIG. 1, air does not leak from the air chambers 20 filled with air. Accordingly, even if the packing member 10 of the embodiment is continuously manufactured, it can be cut vertically based on an arbitral setting so that respective cut pieces of the packing member can be filled with air and be used as packing members which can absorb an impact or the like.

In the method for manufacturing the packing member 10 according to the embodiments, the packing member 10 can be continuously manufactured by using a mold for thermal adhesion having a plurality of rows of introducing passages 23 and air chambers 20 shown in FIGS. 5A and 5B to perform continuous thermal adhesion on respective plastic films 31, 32, and 33. For example, the first and the third plastic films 31 and 33 are subjected to continuous thermal adhesion in a mold, the thermally adhered plastic films 31 and 33 are conveyed to and superimposed on the second plastic film 32, and further thermal adhesion is performed so that the packing member 10 is continuously manufactured. Thus, the packing member 10 can be manufactured easily without using check valves.

As shown in FIGS. 2A and 2B, the injection port 11 formed between the first plastic film 31 and the third plastic film 33 is formed so as to facilitate air injection by expanding the width of the uppermost film to form a space between the first plastic film 31 and the third plastic film 33 so that air injection using a straw or the like is facilitated.

While the method for manufacturing the packing member 10 by using three plastic films has been explained above, a method for manufacturing a packing member by using four plastic films can also be performed similarly. The method for manufacturing a packing member by using four plastic films can be performed in a manner similar to the method for manufacturing with three plastic films by preliminarily forming portions serving as the blowing-in ports 24 on the third and the fourth plastic films 33 and 34 by using many thin blades, printing or applying release agent thereon, and sandwiching the third and the fourth plastic films 33 and 34 between the first and the second plastic films 31 and 32.

The plastic film 30 constituting the packing member 10 is obtained by laminating a film with thermal sealing property such as polyethylene or polypropylene and a film such as polyamide, fluorine resin, or silicon on each other. The reason for exposing one face of the plastic film having sealing property is that inner faces of the films must be thermally adhered with each other in order to manufacture the packing member 10 body as a bag. The plastic film constituting the packing member 10 of the embodiment may be constituted by sandwiching a film such as polyamide, fluorine resin, or silicon, and then laminating both faces of the film with a film with thermal sealing property such as polyethylene or polypropylene.

As explained above, the packing member of the embodiment can be used to wrap and pack a packed material to absorb an impact applied on the packed material, and can stably pack the packed material therein.

The method for manufacturing a packing member according to the embodiments can easily and continuously manufacture a packing member having air chambers absorbing an impact.

What is claimed is:

1. A packing member for packing a material and configured to be inflated with a gas, comprising:
a plurality of plastic films;
an injection port through which the gas is injected for an inflation of the packing member;
a plurality of air chambers formed by partial adhesions of corresponding plastic films and configured to accommodate the gas;
an air accommodating portion that is provided for each of the air chambers and configured to be inflated with the gas; and
a blowing-in port that is provided for each of the air accommodating portion and configured to provide a path of the gas into the air accommodating portion,
wherein the blowing-in port comprises a slit formed in one of the plastic films that is flexible enough to expand so that the slit is closed when the slit is pushed against another of the plastic films upon the inflation.

2. The packing member of claim 1, wherein the packing member comprises four plastic films, and the blowing-in port comprises another slit formed in a plastic film arranged next to the one of the plastic films.

3. The packing member of claim 1, wherein the another of the plastic films is wider than the one of the plastic films so that an edge portion of the another of the plastic films is adhered to the one of the plastic films so as to form the injection port.

4. The packing member of claim 1, wherein the air chambers are formed in a polygonal shape or a circular shape.

5. The packing member of claim 1, further comprising a communication passage connected with the injection port, wherein the air chambers are aligned in rows that extend from the communication passage.

6. A method for manufacturing a packing member for packing a material and configured to be inflated with a gas, comprising:
disposing a patterned layer of a release agent on a first plastic film;
cutting slits in the first plastic film;
adhering thermally a second plastic film to the first plastic film having the slits and the patterned layer so that an inlet portion and a passage of the gas are formed where the patterned layer is disposed; and
adhering thermally a third plastic film to the first plastic film adhered to the second plastic film so that a discrete air chamber is formed for each of the slits between the first and third plastic films.

7. The method of claim 6, wherein the second plastic film is wider than the first plastic film, and the adhering of the first and second plastic films is such that an edge portion of the second plastic film is adhered to the first plastic film so as to form an injection port that is connected with the passage of the gas.

8. The method of claim 6, wherein the passage of the gas comprises a communication passage and a plurality of introducing passages introducing the gas to the air chambers and connected with the communication passage, and the adhering of the first and third plastic films is such that air chambers are arranged along corresponding introducing passages to form a matrix.
